(19) United States
(12) Patent Application Publication
(10) Pub. No.: US 2011/0024036 A1
(43) Pub. Date: Feb. 3, 2011

(54) RADIO FREQUENCY IDENTIFICATION DEVICE SUPPORT FOR HYBRID CARD AND ITS MANUFACTURING METHOD

(75) Inventor: Pierre BENATO, Roouefort Les Pins (FR)

Correspondence Address: JAMES C. LYDON, 100 DAINGERFIELD ROAD, SUITE 100, ALEXANDRIA, VA, 22314, US

(73) Assignee: ASK S.A.

(21) Appl. No.: 12/844,504

(22) Filed: Jul. 27, 2010

(30) Foreign Application Priority Data
Jul. 28, 2009 (FR) 0903703

(51) Int. Cl. B32B 38/14

(52) U.S. Cl. 156/277

(57) ABSTRACT

The invention concerns a method for manufacturing a radio frequency identification device (RFID) support (52) featuring an antenna (42) and a double-sided integrated circuit module (10) featuring internal contacts (13, 14) and external contacts (12) connected to a chip (15) encased in a module, the method including the following steps:
printing the antenna (42) having contacts (43 and 44) on a support (40),
creating a recess (41) between the contacts (43 and 44) of the antenna,
pasting a film of glue (110) on the internal face of the module except on the internal contacts (13, 14),
positioning the module on the support (40) on the antenna side and so that the internal contacts of the module are against the antenna contacts and the encapsulation (18) of the chip is in the recess,
laminating together the support layer (40) and the module so as to connect the module to the antenna and to glue the module.

### TECHNICAL FIELD

This invention concerns radio frequency identification devices designed to be built into communicating objects and specifically concerns a radio frequency identification device support for hybrid card and its manufacturing method.

### BACKGROUND ART

Contactless radio frequency identification devices (RFIDs) are increasingly used for identification of persons moving about in controlled access zones or transiting from one zone to another. A contactless RFID is a device made up of an antenna and a chip connected to the terminals of the antenna. The chip is usually not powered and receives its energy by electromagnetic coupling between the antenna of the reader and the antenna of the RFID, information is exchanged between the RFID and the reader and particularly information stored in the chip that relates to the identification of the holder of the object on which the RFID is located and to his/her authorization to enter into a controlled access zone.

The hybrid contact-contactless smart cards contain such an RFID, except that the exchange of data with the reader can also take place by contact on flush and conducting contact pads of the card connected to the chip. The chip is thus integrated in a circuit whose external face features the groups of flush contacts. The chip is also connected to the internal face of the circuit designed to connect to the card's antenna. Thus, the chip is connected to both sides of a double-sided circuit to form a double-sided integrated circuit module once encapsulated. Generally speaking, the method for manufacturing contact-contactless hybrid smart cards includes the following steps:
a manufacturing step of the antenna on a support,
a step for laminating the card bodies onto the antenna support consisting in welding, on each side of the support, at least two sheets of plastic material, forming the card bodies, by a hot press molding technique,
a cavity milling step consisting in piercing, in one of the card bodies, a cavity for housing the module comprised by the chip and the double-sided circuit, the cavity including a smaller internal portion which receives the chip and a larger external portion for receiving the double-sided circuit, the milling operation enabling the contacts to be moved apart from the chip, and
a module insertion step consisting in using a glue to secure the module and a conductive glue to connect the module to the contacts, and to position it in the cavity provided for this purpose.

However, this manufacturing method does not provide a semi-finished product equipped with the module and the antenna connected together since the connection of the module is done during the last manufacturing step. Such semi-finished products equipped with the module and the antenna connected together would allow manufacturers who are not specialized in electronics to manufacture and customize hybrid smart cards by procuring these products.

Furthermore, the module milling and insertion steps are performed on one single card at a time, which represents a drawback for efficiency.

There are methods for producing RFIDs that include an antenna and a chip connected together on a support, the assembly obtained being commonly referred to as an “inlay”. It is also known that such inlays are also produced for hybrid contact-contactless smart cards with a copper antenna by a method including the following steps:
a manufacturing step of the antenna on a support provided with a recess located between the antenna contacts,
a step to introduce the module into the recess on the side of the support opposite that supporting the antenna,
a step to connect the module to the antenna contacts,
a step to glue a layer on the antenna so as to embed the antenna in the inlay.

The drawback of this process resides in the complex embodiment of the connection between the antenna and the chip. Actually, this step of the method comprises a set of sub-steps consisting in producing a connecting pit in the thickness of the antenna support in line with the antenna contacts, in filling these wells with a conducting material so as to make a reliable electric connection between the antenna contacts and the internal contacts of the double-sided circuit through the thickness of the support. Furthermore, the inlay manufactured according to this method includes at least two rigid layers between which the antenna is inserted.

### SUMMARY OF THE INVENTION

This is why the purpose of the invention is to counter these drawbacks by offering an RFID support or flexible “inlay” featuring a double-face integrated circuit connected to an antenna.

Another object of the invention is to provide a hybrid contact-contactless smart card integrating such a support.

The object of the invention is thus a method for manufacturing a radio frequency identification device (RFID) support featuring an antenna and a double-sided integrated circuit module featuring internal contacts and external contacts connected to a chip encased in a module, the method including the following steps:
printing the antenna featuring contacts on a support,
creating a recess between the contacts of the antenna,
pasting a film of glue on the internal face of the module, pierced by two recesses at the location of the internal contacts,
positioning the module on the support on the antenna side and so that the internal contacts of the module are against the antenna contacts and the chip encapsulation of the chip is in the recess,
laminating together the support layer and the module so as to glue the module and connect the module to the antenna by deformation of the antenna contacts that fill the recesses in the film of glue and rest against the internal contacts of the module.

### BRIEF DESCRIPTION OF THE DRAWINGS

The purposes, objects and characteristics of the invention will become more apparent from the following description when taken in conjunction with the accompanying drawings in which:

FIG. 1 represents a cross-sectional view of the various components of the “inlay” and the tool for the first lamination according to a first embodiment of the invention,

FIG. 2 represents a cross-sectional view of the various components of the “inlay” and the tool for the first lamination according to a second embodiment of the invention,

FIG. 3 represents the pasting of the modules placed on a strip,

FIG. 4 represents a cross-sectional view of the various layers which make up the hybrid contact-contactless smart card according to the invention.

In the description that follows, the device referred to as the “inlay” designates the radio frequency identification device (RFID) support for hybrid contact-contactless smart card able to communicate, at this stage, with the appropriate reader by contact or remotely.

### DETAILED DESCRIPTION OF THE INVENTION

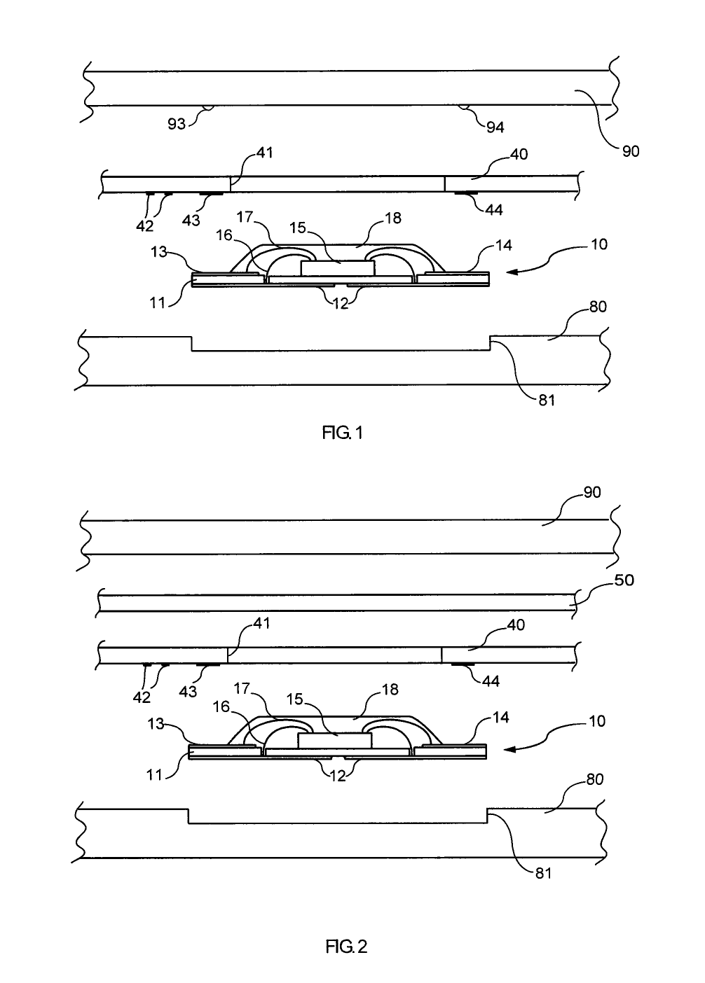

According to FIG. 1, a double-sided integrated circuit module 10 comprises a chip 15 placed on an electrically non-conductive support 11. The chip is connected to two internal contacts 13 and 14 and to external contacts 12 forming the future contacts flush with the surface of the card. The internal contacts 13, 14 and external contacts 12 are located on either side of the support 11. The connections between the chip and the internal and external group of contacts are made by conductive wires or connecting cables 16 and 17, referred to as “wire bonding”. The chip 15 and the wires are encased in a resistant material-based protective resin 18 that does not conduct electricity. The encapsulation 18 is in a way a stiff shell that surrounds the chip and its wiring in order to make it less fragile and easier to handle. The encapsulation has a thickness between 200 and 240 μm. The module thus presents on its upper face a flat surface corresponding to the upper portion of the encapsulation 18 and, at the base of the encapsulation, the internal contacts 13 and 14 designed to connect to the antenna contacts. The contacts 13 and 14 are made of conductive material and their thickness is between 70 and 100 μm.

An antenna is made on a support layer 40. The antenna features a set of one or more turns and at least two contacts 43 and 44. The turns and the contacts are made by screen printing, flexography, rotogravure, offset printing or inkjet printing with epoxy type conductive ink loaded with conductive particles such as for example silver or gold or with a conductive polymer. According to one embodiment, the ink for the antenna contacts is made from a flexible ink. The support layer 40 is preferably made of a non-creeping material (i.e. a material that does not deform under the effect of the temperature) such as paper or synthetic paper (Teslin-type) or possibly another material such as polycarbonate, PET or PVC. The support layer 40 features a recess 41 whose dimensions correspond to those of the encapsulation 18 of the module 10. At this step of the manufacturing method, the ink making up the antenna is not baked, i.e. it has undergone neither heat nor pressure treatment; however, it is dry.

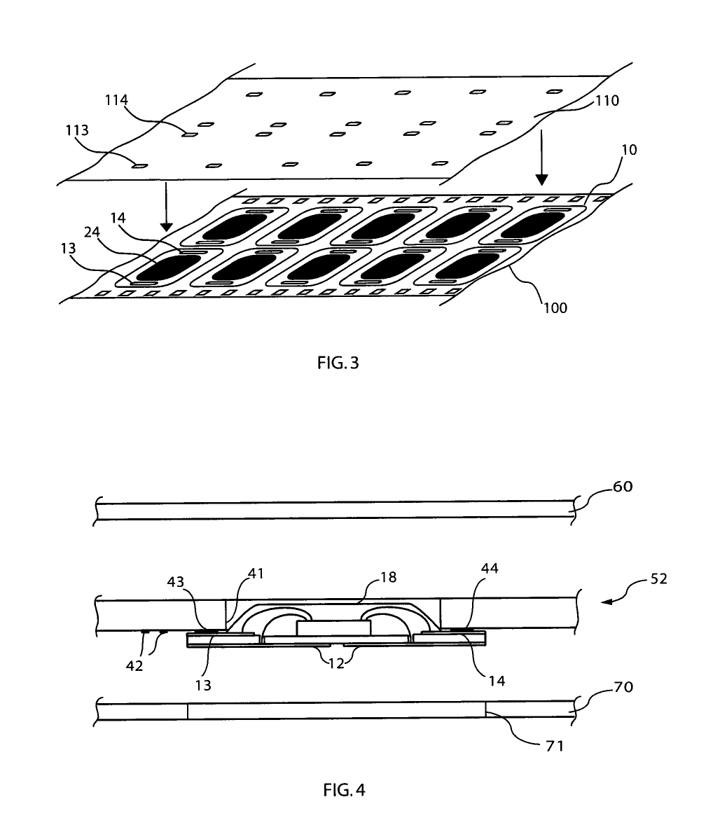

A gluing step of the module is performed at the same time. According to FIG. 3, the modules are generally packaged attached together in the form of a roll 100, part of which is represented in FIG. 3. A roll 110 of glue in film form of width equivalent to the roll of modules is unrolled onto the internal face of the modules 10. A film of glue is pierced by holes 113 and 114 corresponding to the location of the internal contacts 13 and 14 of the modules. The glue of the film is a non-reversible thermofusible type glue, which means that once hardened at a certain temperature, its state does not change even if it is again subjected to the same temperature. The film of glue is applied to the modules by a pre-lamination step at a temperature below its polymerization temperature which irreversibly hardens the glue. The internal surface of the modules is thus covered with a thin film of glue except at the location of the internal contacts 13 and 14 where the film is pierced by two holes 113 and 114.

The module is then placed in a recess 41 of the support 40 so that the internal contacts 13 and 14 are located opposite the antenna contacts 43 and 44. The thickness of the contacts is between 5 and 10 μm.

In order to facilitate positioning the module in relation to the foreseen location on the support 40 and to protect it, a plate 80 made of a hard and pressure-resistant material is provided with a recess 81 corresponding to the imprint of the module placed on its external face, thus on its flush contacts and whose depth corresponds to the height of the module at the location of the internal contacts 13 and 14. This thickness is between 200 and 240 μm depending on the type of module. The module is placed in the recess 81 on its external contacts 12 so that its internal contacts 13 and 14 are visible and accessible. The plate 80 is a tool and is used as a lower lamination plate during the lamination steps that follow. The plate 80 can contain a plurality of recesses 81 in order to produce several cards at a time. In this case, the support layer 40 in the form of a large sheet also contains the same number of antennas. According to one embodiment, the recesses 81 in the lower lamination plate are provided with a magnet designed to retain the module during implementation of the method.

The following step of the method consists in a preliminary lamination that allows the module to be connected to the antenna.

According to a first embodiment, the RFID support is in the form of a single layer 40. The lamination step consists in subjecting all layers to an increase in temperature up to 150° C. and an increase in pressure from 0.5 bar up to a few bar (which corresponds to approximately 10 N/m²) followed by a decrease in temperature and a decrease in pressure, the whole according to a set of cycles of defined duration. During the lamination, an upper lamination plate 90 is also placed on top of the layer 40 and the module. In this way, and owing to the lamination plates 80 and 90, the pressure is uniformly distributed and is exerted on the entire layer 40. Owing to the increase in pressure and temperature, the antenna contacts 43 and 44 deform and fill the cavities 113 and 114 of the film of glue until they rest against the internal contacts 13 and 14 of the module. Thus, there is intimate contact between the internal contacts 13 and 14 of the module and the conductive ink of contacts 43 and 44 on a maximum contact surface due to the deformation and crushing of the ink of the antenna contacts and their bonding to the contacts 13 and 14 of the module. The electrical connection between the module and the antenna is made. Furthermore, during the increase in temperature and pressure, the film of glue 110 softens slightly so as to mate with the connection made between the antenna contacts and the internal contacts of the module. Owing to the decrease in temperature, the film of glue hardens and maintains the contact between the module and the antenna contacts. The temperature reached is such that the glue reaches its threshold of irreversibility, i.e. that it will not soften even when heated to an equal or higher temperature. According to one embodiment, the upper lamination plate 90 is provided with protrusions 93 and 94. These protrusions are located on plate 90 so that, during the first lamination step, they are aligned vertically with contacts 43 and 44 of the antenna and recesses 113 and 114 in the film of glue. During the first lamination step, the protrusion press the contacts 43 and 44 through layers 50 and 40 in order to have the contacts deformed and stamped into recesses 113 and 114 in the film of glue.

The conductive ink of the contacts being deformable although non-elastic, the antenna contacts do not tend to return to their original shape even when the pressure is released. A hybrid contact-contactless smart card inlay is thus obtained in which the module is prominent in relation to the antenna support.

According to a second embodiment, a layer of PVC 50 is placed on the support layer 40 prior to the first lamination step on the face of the support opposite that on which the antenna is printed. During the lamination, this layer softens and welds itself to the antenna support layer 40.

The radio frequency identification device support or inlay 52 produced has a total thickness of 570 μm (+/−10%), 220 μm of which corresponds to the protrusion of the module in relation to the antenna support layer.

The hybrid contact-contactless smart card is completed after a second lamination step consisting in applying pressure and heat. Two layers 60 and 70 are positioned on either side of the inlay 52 obtained according to any one of the manufacturing methods described above. The external face of the two card bodies 60 and 70 were previously printed with the customized graphic image of the card. The card body 70 placed on the antenna and on the external face of the module 10 is pierced by a recess 71 corresponding to the size of the external contacts 12 of the module. The shape of the recess 71 is such that it matches the edges of the external face of the module 10. A hot press molding technique is used to weld the two card bodies 60 and 70, having a thickness equal to approximately 160 μm, onto both faces of the inlay 52. This step is more like gluing than welding. As a result, the pressure and temperature required in this phase are much lower than those used for the first lamination step. The temperature and pressure necessary for this lamination step are no more than approximately 120° C. and 150 bar, respectively. Furthermore, the duration of the pressurization and temperature cycles is also reduced.

Each card body 60 and 70 consists of one or more layers. When the card bodies have more than one layer, they can be glued together during the lamination process on the inlay or independently.

The material used for the layers 40, 50, 60 and 70 can be polyvinyl chloride (PVC), polyester (PET, PETG), polypropylene (PP), polycarbonate (PC), acrylonitrile-butadiene-styrene (ABS) or a polyurethane (PU) film, paper or synthetic paper such as Teslin.

1-11. (canceled)

12. A method for manufacturing a radio frequency identification device (RFID) support comprising an antenna and a double-sided integrated circuit module, said integrated circuit comprising internal contacts and external contacts connected to a chip encased in the module, said method including the following steps:
printing an antenna having contacts on a support,
creating a recess between the contacts of said antenna,
pasting a film of glue on an internal face of said module, pierced by two recesses at the location of said internal contacts of the module,
positioning said module on said support on the side of said antenna such that said internal contacts of said module are against said contacts of said antenna and such that the encapsulation of the chip is in said recess,
laminating together said support layer and said module so as to glue the module and connect the module to the antenna by deformation of said antenna contacts that fill said recesses and rest against said internal contacts of the module.

13. A method for manufacturing a hybrid contact-contactless smart card comprising the following steps:
placing a card body on either side of the radio frequency identification device support obtained according to claim 12, said card body located on the side of the antenna being pierced by a recess corresponding to the size of the external contacts of the module,
laminating all layers by applying pressure and heat so as to glue the layers together.

14. The method of claim 12, wherein the film of glue pasted on the module is a non-reversible thermofusible glue.

15. The method of claim 12, wherein the layer of said support is made of a material which does not deform when the temperature increases.

16. The method of claim 12, wherein said antenna is made by screen type printing using conductive ink.

17. The method of claim 13, wherein the card bodies comprise several layers laminated together during the lamination step.

18. The method of claim 13, wherein the card bodies comprise several layers laminated together prior to the lamination step.

19. The method of claim 12, wherein a tool used during the lamination steps comprises a lamination plate provided with a recess in which the external face of the module is placed against said plate and so as to leave the internal contacts of the module visible and accessible.

20. The method of claim 19, wherein said recess has a thickness corresponding to a thickness of the module at the location of the internal contacts.

21. The method of claim 19, wherein the tool used during the lamination steps includes an upper lamination plate provided with protrusions located vertically above contacts of the antenna and recesses in the film of glue during the first lamination step.

22. A method for manufacturing a radio frequency identification device (RFID) support comprising an antenna and a double-sided integrated circuit module, said integrated circuit comprising internal contacts and external contacts connected to a chip encased in the module, said method including the following steps:
printing an antenna having contacts on a support,
creating a recess between the contacts of said antenna,
pasting a film of glue on an internal face of said module, pierced by two recesses at the location of said internal contacts of the module,
positioning said module on said support on the side of said antenna such that said internal contacts of said module are against said contacts of said antenna and such that the encapsulation of the chip is in said recess,
positioning a layer on said antenna support on the side opposite that where the antenna is printed,
laminating together said layer, said support layer and said module so as to glue the module and connect the module to the antenna by deformation of said antenna contacts that fill said recesses and rest against said internal contacts of the module.

23. A method for manufacturing a hybrid contact-contactless smart card comprising the following steps:
placing a card body on either side of the radio frequency identification device support obtained according to claim 22, said card body located on the side of the antenna being pierced by a recess corresponding to the size of the external contacts of the module,
laminating all layers by applying pressure and heat so as to glue the layers together.

24. The method of claim 22, wherein the film of glue pasted on the module is a non-reversible thermofusible glue.

25. The method of claim 22, wherein the layer of said support is made of a material which does not deform when the temperature increases.

26. The method of claim 22, wherein said antenna is made by screen type printing using conductive ink.

27. The method of claim 23, wherein the card bodies comprise several layers laminated together during the lamination step.

28. The method of claim 23, wherein the card bodies comprise several layers laminated together prior to the lamination step.

29. The method of claim 22, wherein a tool used during the lamination steps comprises a lamination plate provided with a recess in which the external face of the module is placed against said plate and so as to leave the internal contacts of the module visible and accessible.

30. The method of claim 29, wherein said recess has a thickness corresponding to the thickness of the module at the location of the internal contacts.

31. The method of claim 29, wherein the tool used during the lamination steps includes an upper lamination plate provided with protrusions located vertically above contacts of the antenna and recesses in the film of glue during the first lamination step.
